(19) United States
(12) Patent Application Publication
(10) Pub. No.: US 2015/0222673 A1
(43) Pub. Date: Aug. 6, 2015

(54) IMAGE PROCESSING APPARATUS, IMAGE PROCESSING METHOD, AND COMPUTER PROGRAM

(71) Applicant: SONY COMPUTER ENTERTAINMENT INC., TOKYO (JP)

(72) Inventor: Tatsuya Suzuki, Tokyo (JP)

(21) Appl. No.: 14/421,468

(22) PCT Filed: Apr. 24, 2013
(86) PCT No.: PCT/JP2013/002782

§ 371 Date: Feb. 13, 2015

(30) Foreign Application Priority Data
Sep. 19, 2012 (JP) 2012-206172

(51) Int. Cl. H04L 29/06; G06F 3/0488; G06T 11/60; G06F 3/0484; G06T 11/20; G06F 17/30

(52) U.S. Cl. CPC H04L 65/403; G06T 11/20; G06F 17/3028; G06T 11/60; G06F 3/04845; G06F 3/04883

(57) ABSTRACT

A user terminal 300 has a theme presenting section 320 configured to present a theme of an image to a user, a drawing control section 313 configured to accept drawing of an image from the user, an image presenting section 321 configured to, when the drawing control section 313 accepts drawing of an image based on the theme presented by the theme presenting section 320 from the user, acquire, from a comment information managing server that manages comment information posted by a plurality of users, an image drawn by another user on the basis of the theme presented by the theme presenting section 320 and posted to the comment information managing server, and present the acquired image, and a comment information posting section 312 configured to post the image drawn by the drawing control section 313 to the comment information managing server.

### TECHNICAL FIELD

The present invention relates to an image processing technology and, more particular, to an image processing apparatus, an image processing method, and a computer program for processing an image drawn by a user.

### BACKGROUND ART

Information terminals and game apparatuses having touch panels are in a wide use. Various applications are provided that make the most of the features of touch panels that allow these terminals and apparatuses to be manipulated through direct finger touch on a screen displayed on a display apparatus.

### SUMMARY

### Technical Problem

Many users are not familiar with the interface through which an image is drawn with a finger on a touch panel. Therefore, it is necessary to provide an interface having higher convenience. In addition, it is desired to provide services that place emphasis on the communication with other users and allow users who feel difficulty in image drawing.

In this background, a purpose of the present invention is to provide an image processing technology that is higher in convenience.

### Solution to Problem

One aspect of the present invention relates to a computer program. This computer program causes a computer to function as: a theme presenting section configured to present a theme of an image to a user; a drawing control section configured to accept drawing of an image from the user; an image presenting section configured to, when the drawing control section accepts drawing of an image based on the theme presented by the theme presenting section from the user, acquire, from a comment information managing server that manages comment information posted by a plurality of users, an image drawn by another user on the basis of the theme presented by the theme presenting section and posted to the comment information managing server, and present the acquired image; and a posting section configured to post the image drawn by the drawing control section to the comment information managing server.

Another aspect of the present invention relates to a computer program. This computer program causes a computer to function as: a drawing control section configured to accept an input by a user into a touch pad, draw an image in accordance with the input, and display the drawn image onto a screen; and an enlarge display control section configured to, upon accepting the input by the user into the touch pad, display an enlarged image of an image drawn around a position of the input and a figure indicative of the input position onto the screen, wherein the drawing control section, upon accepting a first operation instruction, does not draw an image at the input position even if the input by the user into the touch pad has been accepted and, upon accepting a second operation instruction, restarts drawing of an image in accordance with the input into the touch pad.

It is to be noted that also an arbitrary combination of the components described above and the representation of the present invention where it is converted between different ones of a method, an apparatus, a system, and so forth are effective as modes of the present invention.

### Advantageous Effect of Invention

According to the present invention, a drawing control technology that is higher in convenience can be provided.

### BRIEF DESCRIPTION OF DRAWINGS

FIG. 1 is a diagram illustrating an overall configuration of an information processing system related to an embodiment.

FIG. 2 is a diagram illustrating a functional configuration of a comment information managing server.

FIG. 3 is a diagram illustrating an example of internal data of a comment information database.

FIG. 4 is a diagram illustrating a functional configuration of a point managing server.

FIG. 5 is a diagram illustrating an example of internal data of a user database.

FIG. 6(a) is a diagram illustrating a front side of a game apparatus and FIG. 6(b) is a diagram illustrating a rear side of the game apparatus.

FIG. 7(a) is a diagram illustrating an upper side of the game apparatus, FIG. 7(b) is a diagram illustrating a bottom side of the game apparatus, and FIG. 7(c) is a diagram illustrating a left side face of the game apparatus.

FIG. 8 is a diagram illustrating a circuit configuration of the game apparatus.

FIG. 9 is a diagram illustrating a functional configuration of a user terminal related to an embodiment.

FIG. 10 is a diagram illustrating an example of an enlarged display screen displayed by an enlarged display control section.

FIG. 11 is a diagram illustrating an example of a screen displayed on a display apparatus.

FIG. 12 is a diagram illustrating an example of a screen displayed on the display apparatus.

FIG. 13 is a diagram illustrating an example of a screen displayed on the display apparatus.

FIG. 14 is a diagram illustrating an example of a screen displayed on the display apparatus.

FIG. 15 is a diagram illustrating an example of a screen displayed on the display apparatus.

FIG. 16 is a diagram illustrating an example of a screen displayed on the display apparatus.

FIG. 17 is a diagram illustrating an example of a screen displayed on the display apparatus.

FIG. 18 is a diagram illustrating an example of a screen displayed on the display apparatus.

FIG. 19 is a diagram illustrating an example of a screen displayed on the display apparatus.

FIG. 20 is a diagram illustrating an example of a screen displayed on the display apparatus.

FIG. 21 is a diagram illustrating an example of a screen displayed on the display apparatus.

FIG. 22 is a diagram illustrating an example of a screen displayed on the display apparatus.

FIG. 23 is a diagram illustrating an example of a screen displayed on the display apparatus.

FIG. 24 is a flowchart indicative of a procedure of an image processing method related to an embodiment.

### DESCRIPTION OF EMBODIMENTS

In embodiments, a function for a user to draw pictures with a user's finger on a touch pad will be described. In the present embodiments, a function is further provided that allows both users good at drawing and users feeling difficulty in drawing to enjoy drawing and seeing pictures while enjoying communication between the users. To be more specific, by use of a mini blog service that allows users to post short text comment information to enjoy chats with other users, functions for posting user-drawn pictures, posting pictures drawn by adding pictures to posted pictures, posting a theme of a picture desired to be drawn, drawing and posting pictures based on a posted theme, and evaluating posted pictures are provided. These functions allow users to enjoy drawing of pictures by himself/herself and seeing pictures drawn by other users while taking communication therewith.

In the present embodiments, while a user draws a picture based on a presented theme, an image drown based on the same theme and posted to a mini blog service is acquired and a function to be displayed on the drawing screen is provided. Consequently, the user is able to see an image posted by another user on the basis of the same theme and draw an image by referencing this posted image, thereby resulting in enhanced user convenience. In addition, a service can be provided in which even users feeling difficulty in drawing pictures are able to enjoy drawing pictures with ease.

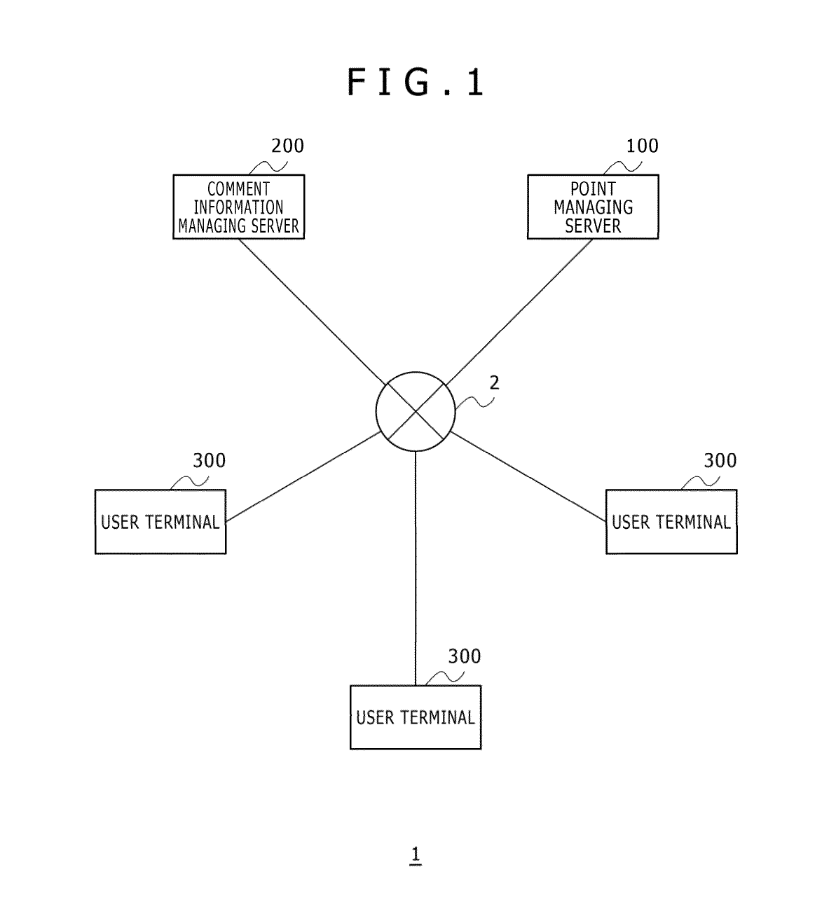

Referring to FIG. 1, there is shown an overall configuration of an information processing system related to an embodiment. The information processing system 1 has a comment information managing server 200 for providing a mini blog service for delivering comment information posted by a user, a user terminal 300 for executing an image processing application using the mini blog service, and a point managing server 100 for managing points given to the user for the use of the image processing application. The user terminal 300 posts comment information to the comment information managing server 200 through the Internet 2, one example of networks, thereby acquiring the posted comment information. In addition, the user terminal 300 requests the point managing server 100 for adding of points through the Internet 2, thereby browsing a point state.

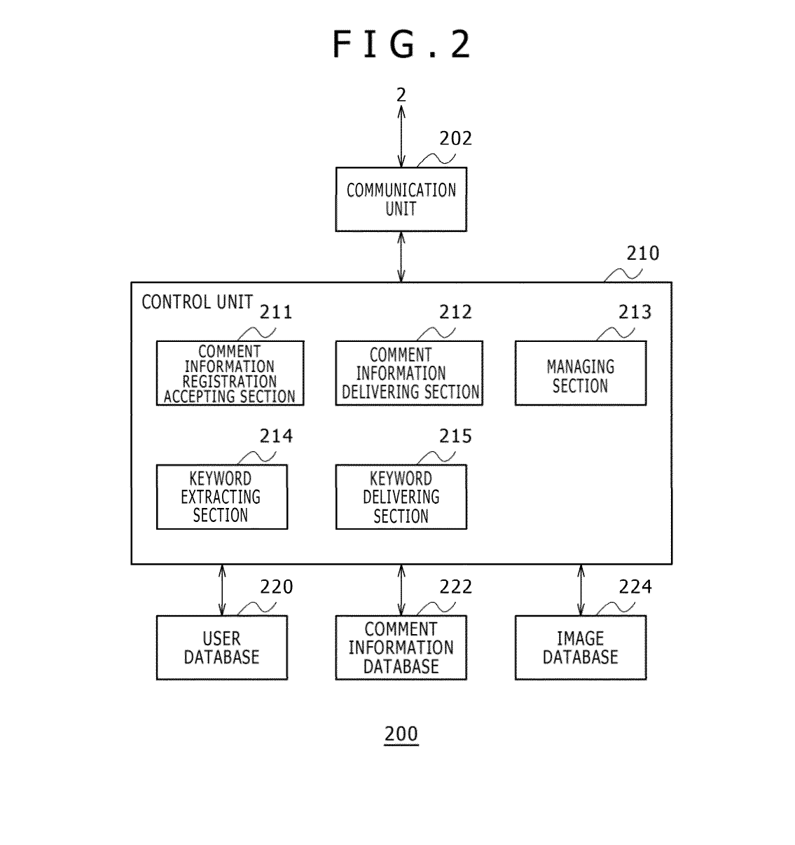

Referring to FIG. 2, there is shown a functional configuration of the comment information managing server 200. The comment information managing server 200 has a communication unit 202, a control unit 210, a user database 220, a comment information database 222, and an image database 224. In terms of hardware components, these configurations may be realized by a CPU, a memory, and a program loaded in the memory of any given computer; in FIG. 2, functional blocks that are realized by the linking of these are shown. Consequently, it is understandable to those skilled in the art that these functional blocks may be realized in various forms by hardware alone, software alone, and combinations thereof.

The communication unit 202 controls communication between the user terminal 300 and the point managing server 100 through the Internet 2.

The user database 220 stores information of a user who uses a mini blog service provided by the comment information managing server 200. A managing section 213 accepts information of the user from the user terminal 300 before the use of the mini blog service by the user and registers the accepted information into the user database 220. The user database 220 stores the ID, name, nickname, credential information, and attribute information of the user. Further, the user database 220 stores information of a target user whose comment information is browsed by the user. If the target user publicizes the comment information to unspecified users, the managing section 213, upon acceptance of a target user registration request from the user, registers the information of the target user into the user database 220. If the target user restricts the publication of comment information, then the managing section 213, upon acceptance of the target user registration request from the user, requests the target user for the publication of comment information to that user and, when approval is given by the target user, registers the information of the target user into the user database 220. The user database 220 further stores the information of the user registered as a target user.

The comment information database 222 stores comment information with the registration accepted from the user terminal 300. The image database 224 stores the data of an image with the registration accepted from the user terminal 300.

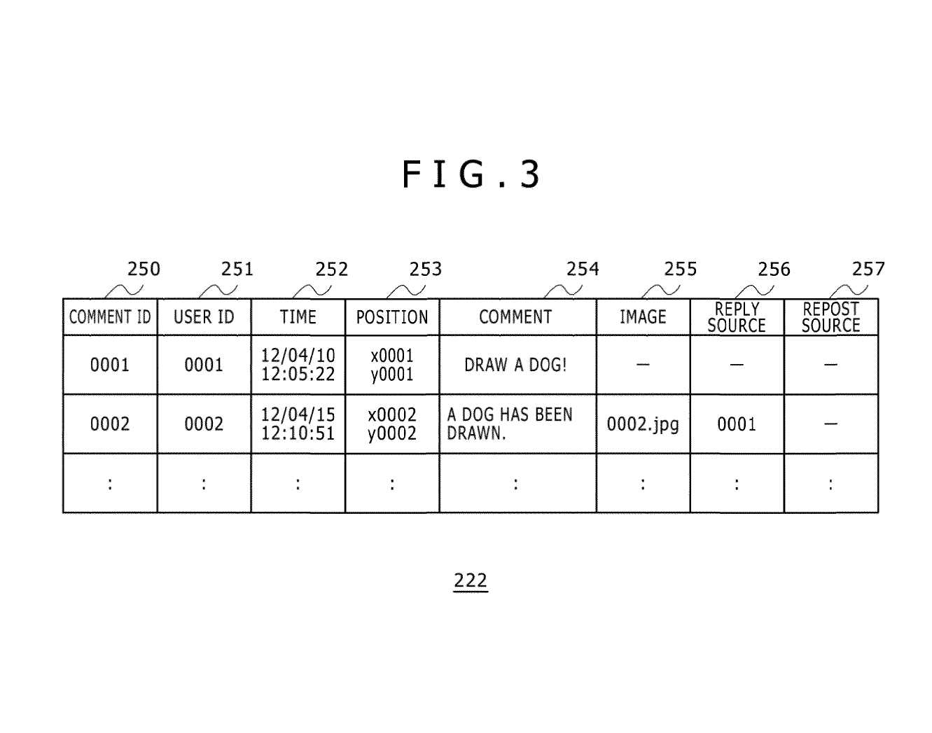

Referring to FIG. 3, there is shown an example of internal data of the comment information database 222. In the comment information database 222, a comment ID column 250, a user ID column 251, a time column 252, a position column 253, a comment column 254, an image column 255, a reply source column 256, and a repost source column 257. The comment ID column 250 stores IDs for uniquely identifying comment information. The user ID column 251 stores IDs of users who have registered comment information. The time column 252 stores time information related to comment information. The position column 253 stores positional information related to comment information. The positional information may be information indicative of latitude and longitude, for example. The comment column 254 stores user comments. The image column 255 stores information for accessing data of images related to comment information. The reply source column 256 stores IDs of comment information of reply source when a user posts comment information to reply to posted comment information. The repost source column 257 stores IDs of comment information of repost source when a user reposts posted comment information.

Returning to FIG. 2, the control unit 210 includes a comment information registration accepting section 211, a comment information delivering section 212, a managing section 213, a keyword extracting section 214, and a keyword delivering section 215.

The comment information registration accepting section 211 accepts registration of comment information from the user terminal 300. The comment information registration accepting section 211 registers the comment information accepted from the user terminal 300 and the time information and the positional information related to the comment information into the comment information database 222. The comment information registration accepting section 211 registers image data into the image database 224 if the image data is related to the comment information and, at the same time, information for accessing the image data into the comment information database 222. Before the registration of the comment information, the comment information registration accepting section 211 may reference the user database 220 to authenticate the user terminal 300. If the comment information accepted from the user terminal 300 is posted as a reply to another piece of comment information, the comment information registration accepting section 211 registers the ID of the comment information of the reply source into the comment information database 222. If the comment information accepted from the user terminal 300 is a repost of another piece of comment information, the comment information registration accepting section 211 registers the ID of the comment information of the repost source into the comment information database 222.

The comment information delivering section 212 delivers the comment information registered in the comment information database 222 to the user terminal 300. When the comment information registration accepting section 211 accepts the registration of the comment information from the user terminal 300, the comment information delivering section 212 may reference the user database 220 to deliver the comment information to the user terminal 300 of a user who registers the user of this user terminal 300 as a target user. When acquisition of the comment information is requested by the user terminal 300, the comment information delivering section 212 may reference the user database 220 to read the comment information of the user registered as a target user by the user of this user terminal 300 from the comment information database 222, thereby delivering the comment information thus read. The comment information delivering section 212 may generate a web page for displaying the comment information and deliver the generated web page to the user terminal 300.

Even if the comment information registered by the user not registered as a target user by the user of the user terminal 300 who requested for the acquisition of the comment information includes the ID of the user of the user terminal 300 who requested the acquisition of the comment information, the comment information delivering section 212 delivers this comment information to the user terminal 300. Each user ID is included in comment information with a particular character, “@” for example, prefixed. The comment information delivering section 212 searches for comment information including a character string with the ID of user prefixed with “@” and delivers the retrieved comment information to the user terminal 300.

When the acquisition of comment information including a keyword is requested from the user terminal 300, the comment information delivering section 212 searches for the comment information including the keyword and delivers the retrieved comment information to the user terminal 300. A keyword is included in comment information with a particular character, “#” for example, prefixed. The comment information delivering section 212 searches for comment information including a character string with a keyword prefixed with “#” and delivers the retrieved comment information to the user terminal 300. The comment information delivering section 212 may accept the search for a character string not attached with “#.”

The managing section 213 accepts the information of user from the user terminal 300 to register the accepted information into the user database 220 and, at the same time, manages modification and deletion of the information registered in the user database 220. In addition, the managing section 213 manages the modification and deletion of the information registered in the comment information database 222.

The keyword extracting section 214 extracts a keyword that is high in use frequency from among words included in the comment information posted by the user. The keyword extracting section 214 may extract a keyword included in comment information by use of a known keyword extracting technology. The keyword extracting section 214 may extract a keyword in every predetermined time range or a predetermined region. The keyword delivering section 215 delivers the keyword extracted by the keyword extracting section 214 to the user terminal 300. The keyword delivering section 215 may deliver the extracted keyword when the keyword delivering section 215 is requested for the acquisition of a keyword from the user terminal 300, or with a predetermined timing.

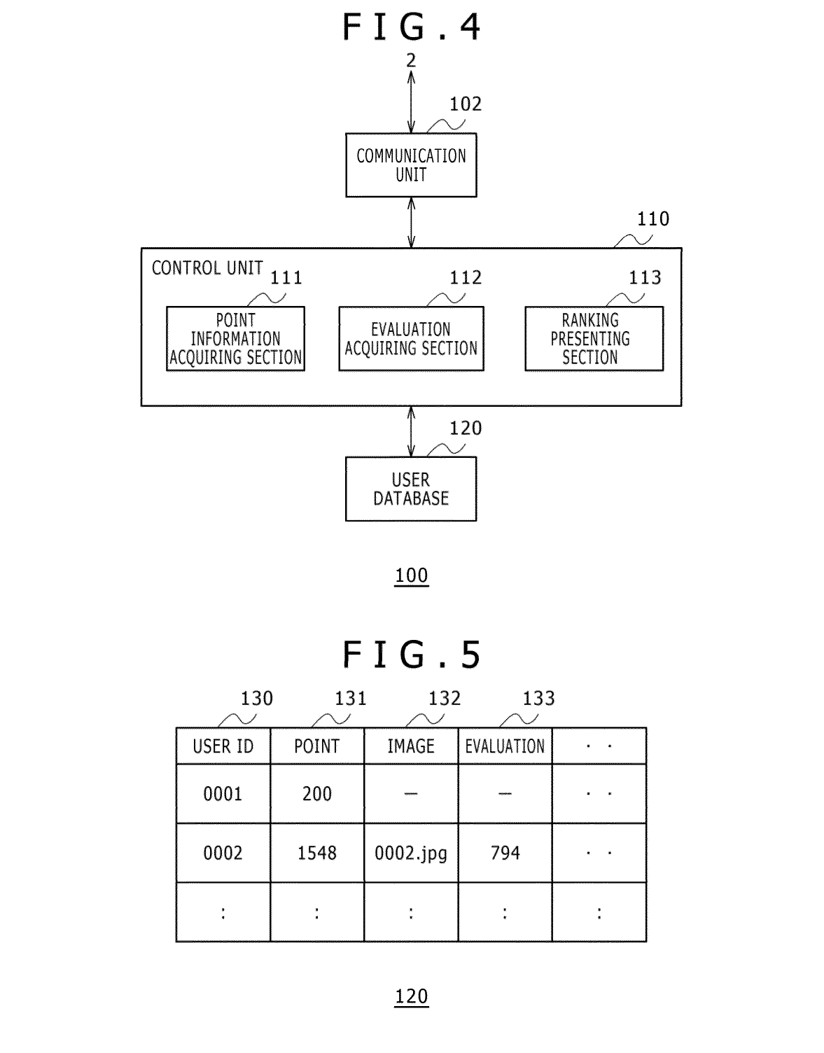

Referring to FIG. 4, there is shown a functional configuration of the point managing server 100. The point managing server 100 has a communication unit 102, a control unit 110, and a user database 120. These configurations may be realized by hardware alone, software alone, or combinations thereof.

The communication unit 102 controls communication between the user terminal 300 and the comment information managing server 200 through the Internet 2.

Referring to FIG. 5, there is shown an example of internal data of the user database 120. In the user database 120, a user ID column 130, a point column 131, an image column 132, and an evaluation column 133 are set. The user ID column 130 stores IDs for uniquely identifying users for which points are managed. The point column 131 stores a total number of points given to a user. The image column 132 stores information for identifying images posted by a user to the comment information managing server 200. The evaluation column 133 stores information indicative of the evaluation for posted images. The image column 132 and the evaluation column 133 are added every time a user posts images to the comment information managing server 200.

Returning to FIG. 4, the control unit 110 includes a point information acquiring section 111, an evaluation acquiring section 112, and a ranking presenting section 113.

The point information acquiring section 111 acquires information related with points of a user from the user terminal 300. As will be described above, in the present embodiment, points are given to a user when comment information attached with a drawn picture or comment information for evaluating an image posted by another user is posted by a user from the user terminal 300. Acquiring the information related with points to be given to a user, the point information acquiring section 111 gives points to the user and updates a record of the corresponding user of the user database 120.

When the user posts an image to the comment information managing server 200, the evaluation acquiring section 112 acquires the information about the posted image from the user terminal 300 or the comment information managing server 200 and registers the acquired information into the user database 120. The evaluation acquiring section 112 acquires the evaluation of the user-posted image from the user terminal 300. If another user reposts the user-posted image or the evaluation for the user-posted image is posted, a point for that image is given to the user. Acquiring the information about the evaluation of the user-posted image, the evaluation acquiring section 112 gives a point to the user who posted that image and updates the corresponding record of the user in the user database 120.

The ranking presenting section 113 presents to the user terminal 300 the ranking of user point or the ranking of posted image evaluation. When the presentation of the ranking of user point or the raking of posted-image evaluation from the user terminal 300, the ranking presenting section 113 references the user database 120 to extract the predetermined number of users high in a total number of points or the predetermined number of images high in evaluation, sorts the extractions, and presents the results to the user terminal 300.

The following describes an external configuration and a circuit configuration of a game apparatus 10 that is one example of the user terminal 300. The game apparatus 10 shown below is a portable game apparatus but may be a portable terminal device of any other types.

### [Front Configuration]

FIG. 6(a) shows the front face of the game apparatus 10. The game apparatus 10 is formed by a wide-rather-than-long housing and the left and right areas each have an arc-shaped shell. On the front face of the game apparatus 10, a rectangular touch panel 50 is arranged. The touch panel 50 is configured by a display apparatus 20 and a transparent front touch pad 21 covering the surface of the display apparatus 20. The display apparatus 20 is an organic EL (Electro-Liminescence) panel that displays images. It should be noted that the display apparatus 20 may be display means such as a liquid crystal display. The front touch pad 21 is a multi-touch pad having a function of detecting multi-points touched at the same time and the touch panel 50 is configured as a multi-touch screen.

To the right side of the touch panel 50, a triangle button 22a, a circle button 22b, a cross button 22c, a square button 22d, (hereafter generically referred to as “operation buttons 22”) are arranged; to the left side of the touch panel 50, an up key 23a, a left key 23b, a down key 23c, a right key 23d (hereafter generically referred to as “direction keys 23”) are arranged. Each of the operation buttons 22 is positioned at the vertices of the rhombus. The user can enter eight directions, up, down, left, right and diagonal by manipulating the direction keys 23. A left stick 24a is arranged below the direction keys 23 and a right stick 24b is arranged below the operation buttons 22. By tiltingly manipulating the left stick 24a or the right stick 24b (hereafter generically referred as “analog sticks 24”), the user enters directions and tilt amounts. On the left and right tops of the housing, an L button 26a and an R button 26b are arranged. The operation buttons 22, the direction keys 23, the analog stick 24, the L button 26a, and the R button 26b make up operation means that are manipulated by the user.

In the proximity of the operation buttons 22, a front camera 30 is arranged. The left side of the left stick 24a and to the right side of the right stick 24b, a left speaker 25a and a right speaker 25b (hereafter generically referred to as “speakers 25”) respectively that output sounds. Below the left stick 24a, a HOME button 27 is arranged and, below the right stick 24b, a START button 28 and a SELECT button 29 are arranged.

### [Rear Configuration]

FIG. 6(b) shows the rear face of the game apparatus 10. On the rear face of the game apparatus 10, a rear camera 31 and a rear touch pad 32 are arranged. Like the front touch pad 21, the rear touch pad 32 is configured as a multi-touch pad. The game apparatus 10 has two cameras and two touch pads on the front and the rear faces.

### [Configuration of Top Section]

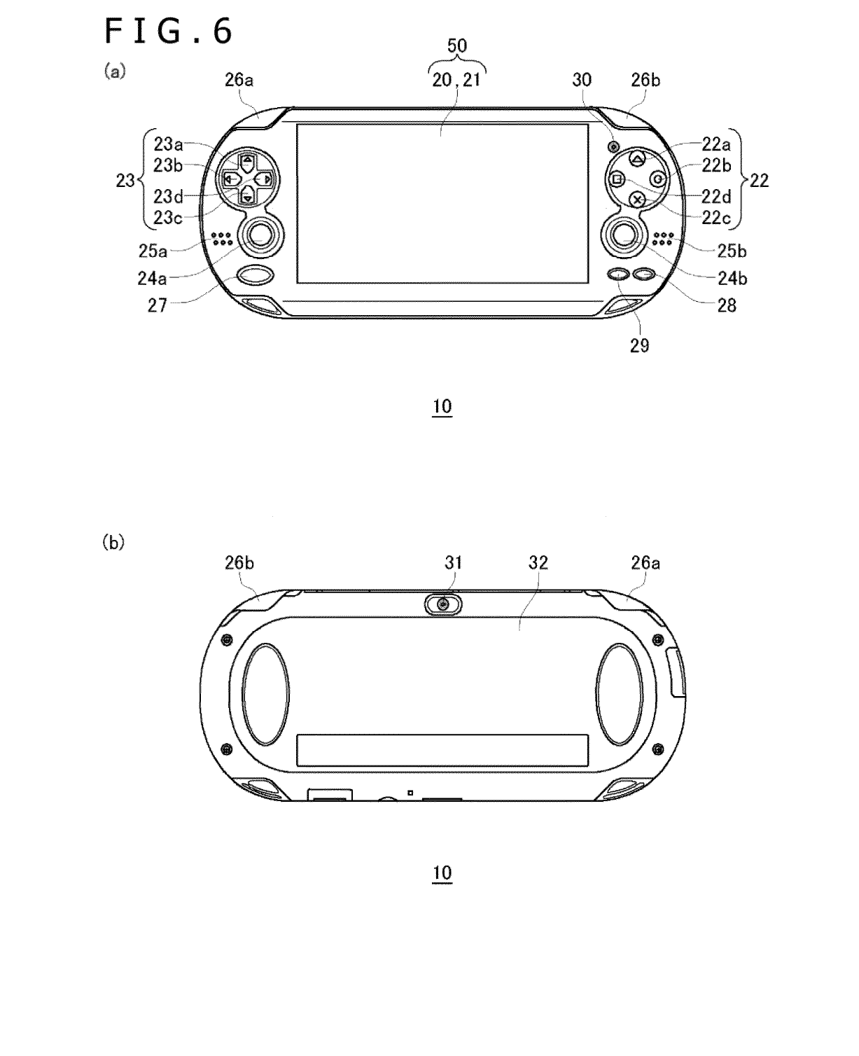

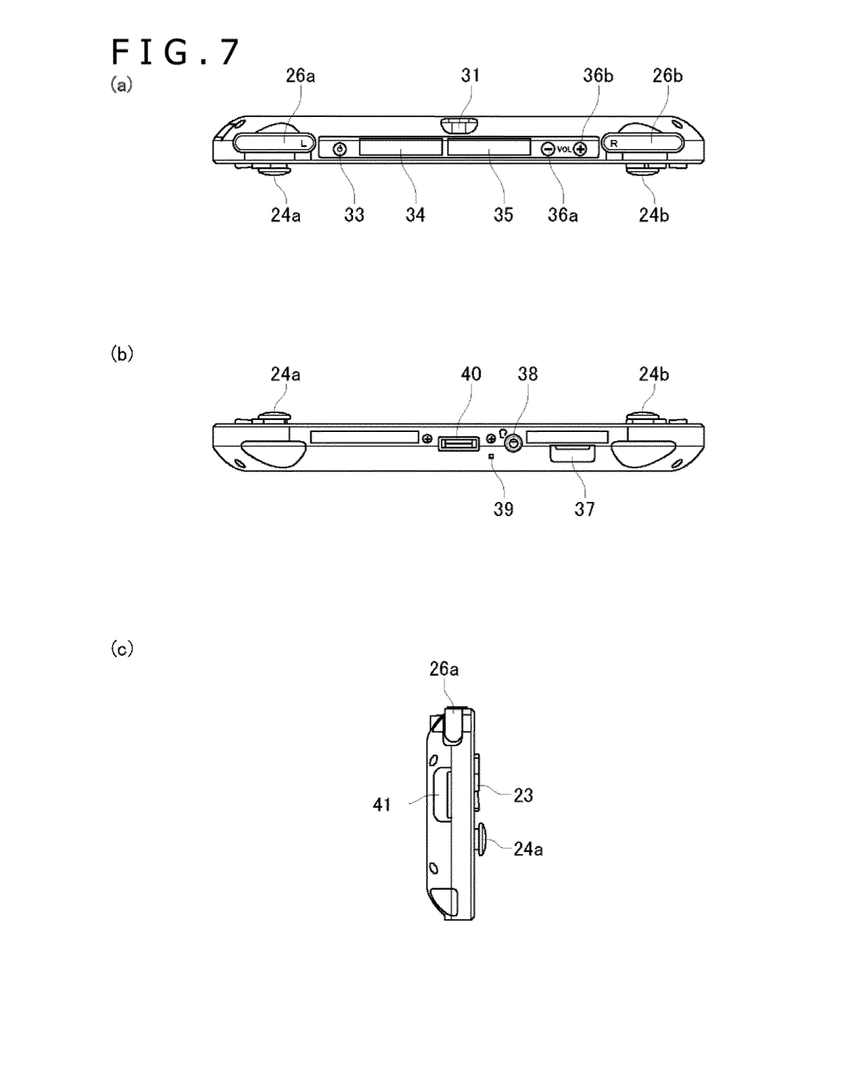

FIG. 7(a) shows a top face of the game apparatus 10. As described above, the L button 26a and the R button 26b are arranged at the left and right ends of the game apparatus 10 respectively. The right side of the L button 26a, a power button 33 is arranged; by pressing the power button 33, the user turns on or off the power. It should be noted that the game apparatus 10 has a power control function for transitioning the game apparatus 10 to a suspend state if a time period (non-manipulation time) in which no control means is manipulated lasts for a certain duration of time. When the game apparatus 10 is in a suspended state, the user is able to restore the game apparatus 10 from the suspend state to an awake state by pressing the power button 33.

A game card slot 34 is a slot through which a game card is inserted; in this figure, a state in which the game card slot 34 is covered with a slot cover is shown. It should be noted that an LED lamp that blinks while the game card is being accessed may be arranged in the proximity of the game card slot 34. An accessory terminal 35 is a terminal for connecting a peripheral device (an accessory); this figure shows a state in which the accessory terminal 35 is covered with a terminal cover. Between the accessory terminal 35 and the R button 26b, a − button 36a and a + button 36b for controlling volume are arranged.

### [Configuration of Bottom Section]

FIG. 7(b) shows a bottom face of the game apparatus 10. A memory card slot 37 is a slot through which a memory card is inserted; this figure shows a state in which the memory card slot 37 is covered with a slot cover. On the bottom face of the game apparatus 10 an audio input/output terminal 38, a microphone 39, and a multi-use terminal 40 are arranged. The multi-use terminal 40 corresponds to a USB (Universal Serial Bus) and can connect to another device through a USB cable.

### [Configuration of Left Side Face]

FIG. 7(c) shows a left side face of the game apparatus 10. On the left side face of the game apparatus 10, a SIM card slot 41 that is a slot for a SIM card is arranged.

### [Circuit Configuration of the Game Apparatus]

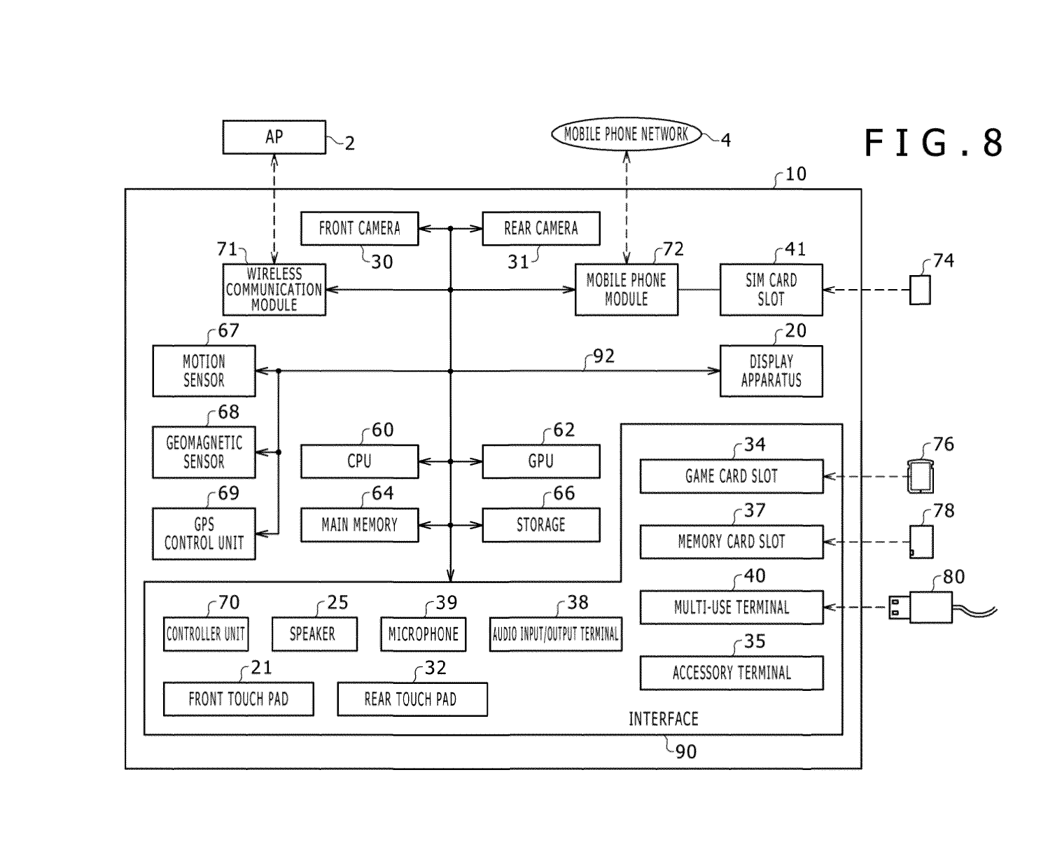

FIG. 8 shows a circuit configuration of the game apparatus 10. Each configuration is mutually connected through a bus 92. A wireless communication module 71 is configured by a wireless LAN module compliant with a communication standard such as IEEE802.11b/g and connects to an external network through an AP 2. It should be noted that the wireless communication module 71 may have a communication function of Bluetooth (registered trademark) protocol. A mobile phone module 72 corresponds to the third generation (3rd Generation) digital mobile phone standard compliant with IMT-2000 (International Mobile Telecommunication 2000) stipulated by ITU (International Telecommunication Union; International Telecommunication Union) and connects to a mobile phone network 4. In the SIM card slot 41, a SIM card 74 recording a unique ID number for identifying the telephone number of a mobile phone is inserted. When the SIM card 74 is inserted in the SIM card slot 41, the mobile phone module 72 becomes ready for communication with the mobile phone network 4.

A CPU (Central Processing Unit) 60 executes a program and so on loaded in a main memory 64. A GPU (Graphics Processing Unit) 62 executes computation necessary for image processing. The main memory 64 is configured by a RAM (Random Access Memory) or the like and stores programs and data that are for use by the CPU 60. A storage 66 is configured by a NAND-type flash memory (NAND-type flash memory) or the like and is used as a built-in auxiliary storage device.

A motion sensor 67 detects motions of the game apparatus 10 and a geomagnetic sensor 68 detects geomagnetism in three-axis directions. A GPS control unit 69 receives a signal from a GPS satellite and computes a current position. The front camera 30 and the rear camera 31 take images and enter image data. Each of the front camera 30 and the rear camera 31 is configured by a CMOS image sensor (Complementary Metal Oxide Semiconductor Image Sensor).

The display apparatus 20 is an organic EL display apparatus and has a light-emitting element that emits light when voltage is applied to the anode and cathode thereof. In a power save mode, the display apparatus 20 can be put in a dark mode by applying a voltage that is lower than normal between the electrodes, thereby saving power dissipation. It should be noted that the display apparatus 20 may be a liquid crystal display panel display apparatus having a backlight. In the power save mode, lowering the quantity of backlight to put the liquid crystal display panel display apparatus in the dark mode, thereby saving power dissipation.

In an interface 90, a controller unit 70 includes each manipulation means in the game apparatus 10; to be more specific, the operation buttons 22, the direction keys 23, the analog sticks 24, the L button 26a, the R button 26b, the HOME button 27, the START button 28, the SELECT 29, the power button 33, the − button 36a, and the + button 36b are included. The front touch pad 21 and the rear touch pad 32 are multi-touch pads, and the front touch pad 21 is arranged on the surface of the display apparatus 20. The speakers 25 output sound generated by each function of the game apparatus 10 and the microphone 39 enters sound around the game apparatus 10. The audio input/output terminal 38 enters stereo sound from an external microphone and outputs stereo sound to an external headphone or the like.

In the game card slot 34, a game card 76 recording a game file is inserted. The game card 76 has a data writable recording area and, when the game card is inserted in the game card slot 34, data read/write operation is executed by a media drive. A memory card 78 is inserted in the memory card slot 37. When loaded in the memory card slot 37, the memory card 78 is used as an externally attached auxiliary storage apparatus. The multi-use terminal 40 may be used as a USB terminal for transmitting and receiving data with other USB devices through the connection of a USB cable 80. To the accessory terminal 35, a peripheral device is connected.

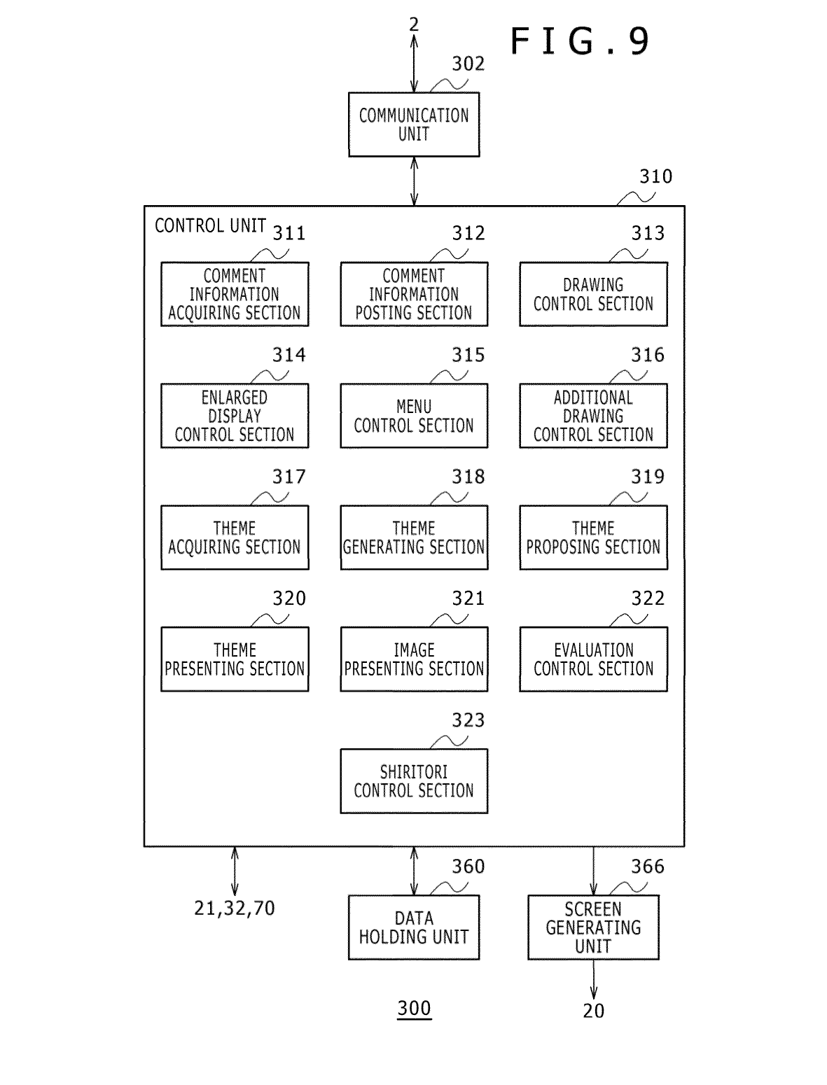

Referring to FIG. 9, there is shown a functional configuration of the user terminal 300 related with an embodiment. The user terminal 300 has a communication unit 302, a control unit 310, a data holding unit 360, and a screen generating unit 366. These configurations may also be realized by hardware alone, software alone, or a combination thereof. The operation and function of each configuration will be described below in detail by referencing drawings.

The communication unit 302 controls communication with the comment information managing server 200 and the point managing server 100 through the Internet 2.

From a recording medium in which an image processing program related with the embodiment is stored, the control unit 310 reads the program and executes the program and, on the basis of an instruction input entered from the controller unit 70, the front touch pad 21, or the rear touch pad 32, conducts image drawing. The screen generating unit 366 generates a screen of the image processing program that is controlled by the control unit 310 and displays the generated screen on the display apparatus 20. The data holding unit 360 holds image data such as a cursor, data necessary for graphics drawing, and data of figures being drawn. The image processing program of the embodiment has a function of acquiring comment information posted to the comment information managing server 200 and a function of posting comment information to the comment information managing server 200 and also functions as a client application of a mini blog service that is provided by the comment information managing server 200.

The control unit 310 includes a comment information acquiring section 311, a comment information posting section 312, a drawing control section 313, an enlarged display control section 314, a menu control section 315, an additional drawing control section 316, a theme acquiring section 317, a theme generating section 318, a theme proposing section 319, a theme presenting section 320, an image presenting section 321, an evaluation control section 322, and a shiritori (Japanese word-chain game) control section 323.

The comment information acquiring section 311 acquires comment information from the comment information managing server 200. The comment information acquiring section 311 requests, with a predetermined timing, the comment information managing server 200 for the acquisition of comment information posted by a user registered as a target of browsing by the user, thereby acquiring the comment information from the comment information managing server 200. The comment information acquiring section 311 acquires not only the comment information posted to the comment information managing server 200 by use of the image processing program related with the embodiment but also the comment information posted to the comment information managing server 200 by use of another client application of a mini blog service that is provided by the comment information managing server 200. Whether the acquired comment information is one posted by use of the drawing control program of the present embodiment or one posted by use of another client application is identified by the identification information of the client application attached to the comment information as will be described later.

The comment information acquiring section 311 acquires, from the comment information managing server 200, with a predetermined timing, a trend keyword high in frequency included in the comment information posted to the comment information managing server 200. In addition, the comment information acquiring section 311 acquires, from the comment information managing server 200, a search result of a character string including a particular character, a character string included in a hash tag starting with “#” for example, included in the comment information posted to the comment information managing server 200, and, if comment information posted by a user is reposted by another user, acquires information about the user who did reposting and the number of times reposting was done.

The comment information posting section 312 transmits the comment information to be posted by the user by use of each function of the image processing program related with embodiment to the comment information managing server 200. The comment information posting section 312 includes a character string indicative of comment information posted by the image processing program related with the embodiment to the comment information to be posted. In addition, the comment information posting section 312 sets the information indicative of the image processing program related with the embodiment as client application information to be set to the comment information to be posted. Consequently, a client application of another apparatus that acquired this comment can recognize that this comment information is the comment information posted by the image processing program related with the embodiment. The comment information posting section 312 includes a character string indicative of the ID of user in the point managing server 100 into the comment information to be posted. Consequently, the image processing program of another apparatus or the point managing server 100 that acquired the comment information can identify the ID of the user who posted the comment information. The encrypted user ID may be included in the comment information.

The drawing control section 313 controls the drawing of an image by the user. The drawing control section 313 displays a drawing screen for accepting drawing from the user onto the display apparatus 20 and, when the user has drawn a figure by moving an input portion such as a finger on the front touch pad 21, acquires the input position from the front touch pad 21 and records the locus of the movement of the input portion into the data holding unit 360, thereby displaying the drawing figure on the display apparatus 20. Accepting a predetermined operation instruction, the drawing control section 313 presents a menu screen for switching between colors, line thicknesses, and line types onto the drawing screen and accepts selections from the user. The drawing control section 313 applies the color, line thickness, and line type selected by the user to the drawn figure.

When the drawing control section 313 is controlling the drawing by the user, the enlarged display control section 314 controls the enlarged display in the proximity of an input portion. When the user touches the front touch pad 21, the enlarged display control section 314 displays an enlarged displayed screen with the periphery of a portion being entered by the user enlarged onto the display apparatus 20. In the enlarged display screen, an image already drawn around the portion being entered by the user is displayed in an enlarged manner and a figure or an object indicative of the position of the portion being entered by the user is displayed. Consequently, the visibility of areas difficult to see as hidden by an input portion such as a finger of the user can be enhanced, thereby enhancing user convenience.

The drawing control section 313 does not draw a figure at an entered position even if a finger of the user touches the front touch pad 21 while a predetermined operation instruction, such as the L button 26a, is being entered for example. Therefore, by touching the front touch pad 21 while entering the L button 26a, the user is able to display the area to be drawing in an enlarged manner without starting drawing. Then, after finely adjusting the input position, drawing can be started by releasing the L button 26a. Consequently, user convenience can be enhanced. This technology is especially effective when the user draws an image with a finger on a touch panel. The drawing control section 313 accepts the input start of the L button 26a as a first operation instruction for stopping drawing and the input end of the L button 26a as a second operation instruction for restarting drawing. Conversely, the drawing control section 313 may accept drawing only when a predetermined operation instruction, the L button 26a is being entered for example. Namely, turn-off of the L button 26a may be accepted as the first operation instruction and turn-on of the L button 26a as a second operation instruction. In addition, every time the L button 26a is entered, switching between turn-on and turn-off may be done.

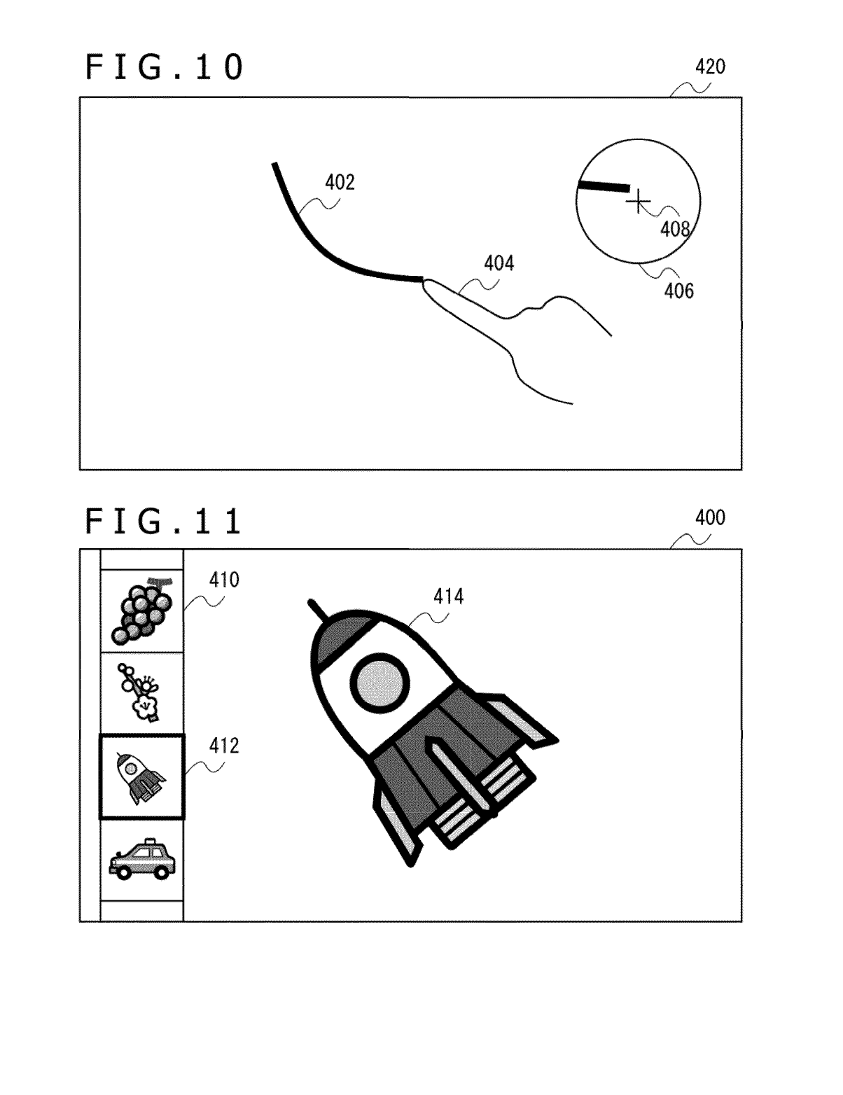

Referring to FIG. 10, there is shown an example of an enlarged display screen that is displayed by the enlarged display control section. On a drawing screen 420 presented by the drawing control section 313, a FIG. 402 drawn by the user is displayed. When a finger 404 of the user touches the front touch pad 21, the enlarged display control section 314 displays an enlarged display screen 406 onto the display apparatus 20. On the enlarged display screen 406, the periphery of a user input position is displayed in an enlarged manner. In addition, a FIG. 408 indicative of a user input position is displayed. For example, when the user tries to draw a next figure by connecting to an end point of the FIG. 402 already drawn by the user and touches the proximity of the end point of the FIG. 402 of the front touch pad 21 with the finger 404 while entering the L button 26a, the enlarged display screen 406 is displayed without starting the drawing of the figure, so that, when the L button 26a is released after moving the finger 404 to match the FIG. 408 with the end point of the FIG. 402, drawing of a next figure can be started just from the end point of the FIG. 402.

The enlarged display control section 314 may increase or decrease the magnification percentage in the enlarged display screen 406 in accordance with a pressing pressure of the finger 404 of the user onto the front touch pad 21, or the like. For example, when the front touch pad 21 is pressed strongly, the proximity of the input position may be displayed in a further enlarged manner; when the front touch pad 21 is pressed weakly, the magnification percentage may be decreased. In accordance with another operation instruction, an input time of the R button 26b for example, the enlarged display control section 314 may increase or decrease the magnification percentage of the enlarged display screen 406.

Returning to FIG. 9, the menu control section 315 presents a menu screen of the functions provided by the drawing control program of the present embodiment onto the display apparatus 20 and accepts the selection of functions from the user. In the present embodiment, functions cooperative with a mini blog service include (1) drawing with an image posted by another user used as a design; (2) drawing with a trend keyword used as a theme; (3) drawing based on a theme generated from a posted image; (4) posting of a theme; (5) drawing based on a theme posted by another user; (6) evaluation of a posted image; and (7) shiritori.

(1) Additional Drawing with an Image Posted by Another User Used as a Design

When the user selects an additional drawing function with an image posted by another user used as a design on the menu screen, then the additional drawing control section 316 acquires images attached to the comment information of other users acquired by the comment information acquiring section 311 from the comment information managing server 200. The theme presenting section 320 displays a list of these images onto the display apparatus 20. The user selects, from the displayed image list, an image to be used as a design. The drawing control section 313 presents a drawing screen for accepting drawing from the user and accepts drawing from the user. At this moment, the additional drawing control section 316 arranges the image selected by the user as a design on the drawing screen in advance. Consequently, the user is able to additionally draw a desired figure to the picture drawn by the user, thereby easily drawing a new picture. If a user is not good at drawing pictures, such a user is able to draw pictures on the basis of a design drawn by another user, the user is given chances of picture drawing to make the user be aware of the joy of picture drawing. It is also practicable for the drawing control section 313 to make uneditable an image arranged on the drawing screen as a design or also make a design modifiable.

When posting an additionally drawn image to the comment information managing server 200 by attaching this image to the comment information, the comment information posting section 312 includes the user ID of the user who posted an image used as a design into the comment information. The user ID is included in the comment information in a form in which this comment information is recognized as a message to the user identified by the user ID. For example, a character string with “@” prefixed to the user ID may be included in the comment information. When an image is posted additionally drawn with an image posted by another user used as a design, the comment information posting section 312 may post comment information attached with an image as a reply or a repost to the comment information attached with an image used as the design. Consequently, the user who posted an image used as a design can easily know that the image additionally drawn to the image posted by the user himself has been posted.

When posting an additionally drawn image to the comment information managing server 200 by attaching this image to the comment information, the comment information posting section 312 may include, in the comment information, a function identification character string indicative that this image was drawn by use of the additional drawing function with an image posted by another user used as a design. This function identification character string may be included in the comment information in a form in which this character string is recognized as a special search target character string. For example, a character string with “#” prefixed to the function identification character string may be included in the comment information.

The additional drawing control section 316 notifies the point managing server 100 of predetermined points to be given to the user when the user has posted an additionally drawn image. Consequently, predetermined points are given to the user who has posted an additionally drawn image by use of an image posted by another user as a design. The additional drawing control section 316 notifies the point managing server 100 of predetermined points to be given to the user who has posted an image used as a design and a predetermined evaluation to be given to the image used as a design. Consequently, predetermined points are also given to the user who has posted a design, thereby increasing the evaluation of the image used as a design.

Referring to FIG. 11, there is shown an example of a screen displayed on the display apparatus. The theme presenting section 320 displays a list 410 of images posted by other users onto a theme presentation screen 400. When the user selects an image 412 that is used as a design from the list 410, the additional drawing control section 316 arranges a selected image 414 on the drawing screen.

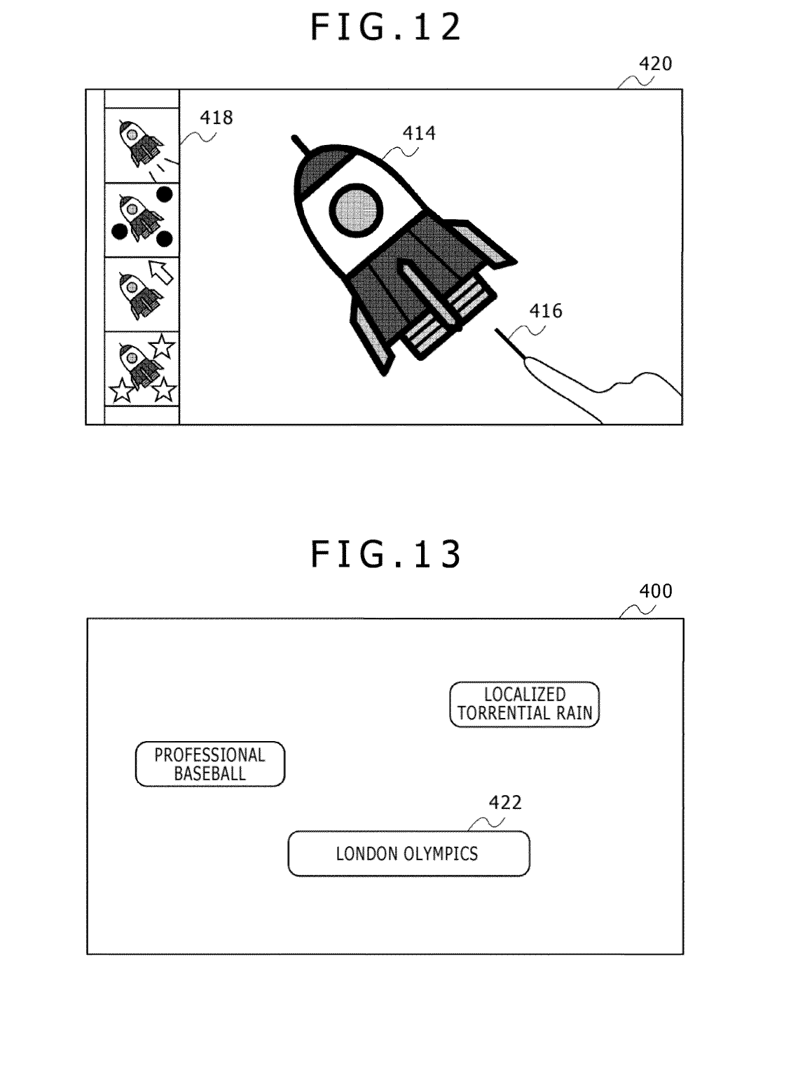

Referring to FIG. 12, there is shown an example of a screen displayed on the display apparatus. On the drawing screen 420, the user is able to newly additionally draw a FIG. 416 and the like with the image 412 as a design. The image presenting section 321 has the comment information acquiring section 311 acquire an image attached to a reply or a repost to the comment information with the image 412 attached and used as a design by the user, thereby displaying a list 418 of attached images onto the drawing screen 420. Of the images attached to the acquired comment information, the image presenting section 321 may extract only images attached to the comment information in which a function identification character string indicative that images are drawn by the additional drawing function with an image posted by another user used as a design is included and display the extracted images on the list 418. Consequently, by use of the same image as a design, the user is able to draw images by seeing and referencing images additionally drawn by other users, thereby enhancing user convenience.

(2) Drawing with a Trend Keyword Used as a Theme

When the user selects a drawing function with a trend keyword used as a theme on the menu screen, the theme acquiring section 317 acquires trend keywords acquired by the comment information acquiring section 311 from the keyword delivering section 215 of the comment information managing server 200. The theme presenting section 320 displays a list of these trend keywords onto the display apparatus 20. From among the displayed trend keywords, the user selects a trend keyword that is used as a theme. The drawing control section 313 presents a drawing screen for accepting drawing from the user onto the display apparatus 20, thereby accepting drawing from the user. At this moment, the theme acquiring section 317 arranges the trend keyword selected as a theme by the user onto the drawing screen in advance.

When posting an image drawn by the user to the comment information managing server 200 by attaching the image to comment information, the comment information posting section 312 includes a trend keyword in the comment information. Each trend keyword is included in comment information in a form in which the trend keyword is recognized as a special search target character string. For example, a character string with “#” prefixed to a trend keyword may be included in comment information. Consequently, another client application and the like can recognize that an image attached to comment information is an image drawn using a trend keyword written to a hash tag included in the comment information as a theme.

When posting an image drawn by the user to the comment information managing server 200 by attaching the image to comment information, the comment information posting section 312 may include, in the comment information, a function identification character string indicative that the image is drawn by use of a drawing function with a trend keyword as a theme in the comment information. As described above, a character string with “#” prefixed to this function identification character string may be included in comment information.

The theme acquiring section 317 notifies the point managing server 100 of predetermined points to be given to the user when the user has posted an image drawn with a trend keyword used as a theme. Consequently, predetermined points are given to the user who has posted an image drawn with a trend keyword used as a theme.

Referring to FIG. 13, there is shown an example of a screen displayed on the display apparatus. The theme presenting section 320 displays a list of trend keywords 422 acquired from the comment information managing server 200 onto the theme presentation screen 400. The user is able to select a theme of an image to be drawn from among the trend keywords displayed in the list.

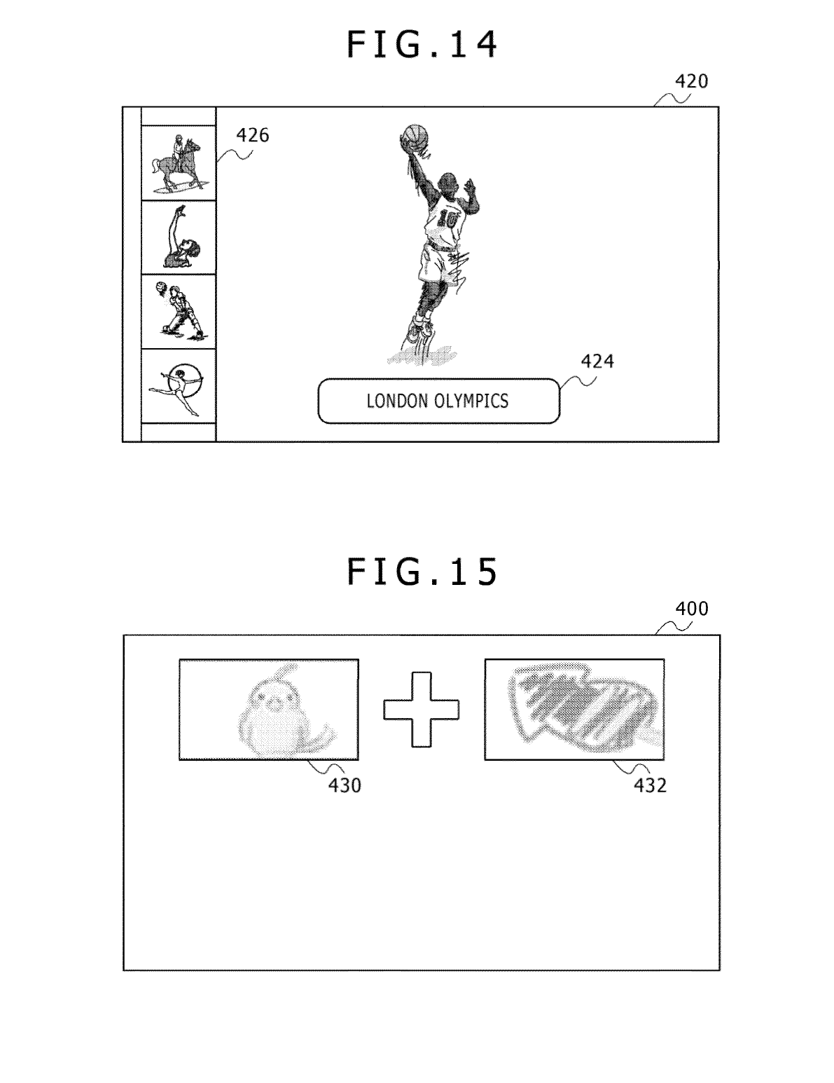

Referring to FIG. 14, there is shown an example of a screen displayed on the display apparatus. On the drawing screen 420, the user is able to draw an image with a selected trend keyword used as a theme. The theme acquiring section 317 arranges a selected trend keyword 424 onto the drawing screen 420 in advance. Consequently, another user is able to know with which theme the image has been drawn only by looking at the image. The image presenting section 321 makes the comment information acquiring section 311 acquire the images attached to the comment information with the selected trend keyword included in a hash tag and displays a list 426 of the attached images onto the drawing screen 420. Consequently, the user is able to draw an image while seeing and referencing an image drawn by another user with the same trend keyword as a theme, so that user convenience is enhanced. When any one of images displayed in the list 426 is selected by the user, the image presenting section 321 arranges the selected image onto the drawing screen 420. Consequently, the user is able to draw an image by use of an image posted by another user as a design.

The theme acquiring section 317 may request the comment information managing server 200 for the acquisition of comment information in which a search keyword accepted from the user is included. Likewise in this case, the theme acquiring section 317 arranges search keywords on the drawing screen 420 in advance. In addition, the image presenting section 321 displays onto the drawing screen a list of images attached to the comment information in which the same search keyword is included. When any one of images displayed in the list is selected by the user, the image presenting section 321 arranges the selected image onto the drawing screen.

(3) Drawing Based on a Theme Generated from a Posted Image

When the user selects, on the menu screen, a drawing function based on a theme generated from a posted image, the theme generating section 318 acquires an image attached to the comment information of another user acquired by the comment information acquiring section 311 from the comment information managing server 200 and generates a theme from the acquired image. The theme presenting section 320 displays the theme generated by the theme generating section 318 onto the display apparatus 20. When the user selects the displayed theme, the drawing control section 313 presents a drawing screen for accepting drawing from the user onto the display apparatus 20, thereby accepting drawing from the user. At this moment, the theme generating section 318 arranges the generated theme on the drawing screen in advance.

When posting an image drawn by the user based on a theme generated by the theme generating section 318 to the comment information managing server 200 by attaching the image to comment information, the comment information posting section 312 includes the user ID of the user who has posted the image used for generating the theme into the comment information. As described above, a character string with “@” prefixed to the user ID may be included in comment information. When posting the image drawn by the user on basis of the theme generated by the theme generating section 318, the comment information posting section 312 may post the comment information with the image attached as a reply or repost to the comment information with the image attached and used for generating the theme. Consequently, the user who has posted an image from which a theme has been generated may easily know that the image drawn on the basis of the theme generated from the image posted by the user himself/herself has been posted.

When posting an image drawn by the user on the basis of a theme generated by the theme generating section 318 to the comment information managing server 200 by attaching the image to comment information, the comment information posting section 312 may include, into comment information, a function identification character string indicative that the image has been drawn by use of a drawing function based on the theme generated from the posted image. As described above, a character string with “#” prefixed to this function identification character string may be included in comment information.

The theme generating section 318 notifies the point managing server 100 of predetermined points to be given to the user when an image drawn on the basis of a theme generated from a posted image has been posted. Consequently, predetermined points are given to the user who has posted the image based on the theme generated from the posted image. The theme generating section 318 notifies the point managing server 100 of predetermined points to be given to the user who has posted the image used for generating the theme and a predetermined evaluation to be given to the image used for generating the theme. Consequently, predetermined points are also given to the user who has posted the image used for generating the theme, thereby increasing the evaluation of the image used for generating the theme.

Referring to FIG. 15, there is shown an example of a screen displayed on the display apparatus. The theme presenting section 320 displays onto the theme presentation screen 400 a theme with two images 430 and 432 posted by other users linked to each other with “+” sign. If the user accepts this theme and draws an image, the theme generating section 318 arranges the theme on the drawing screen 420.

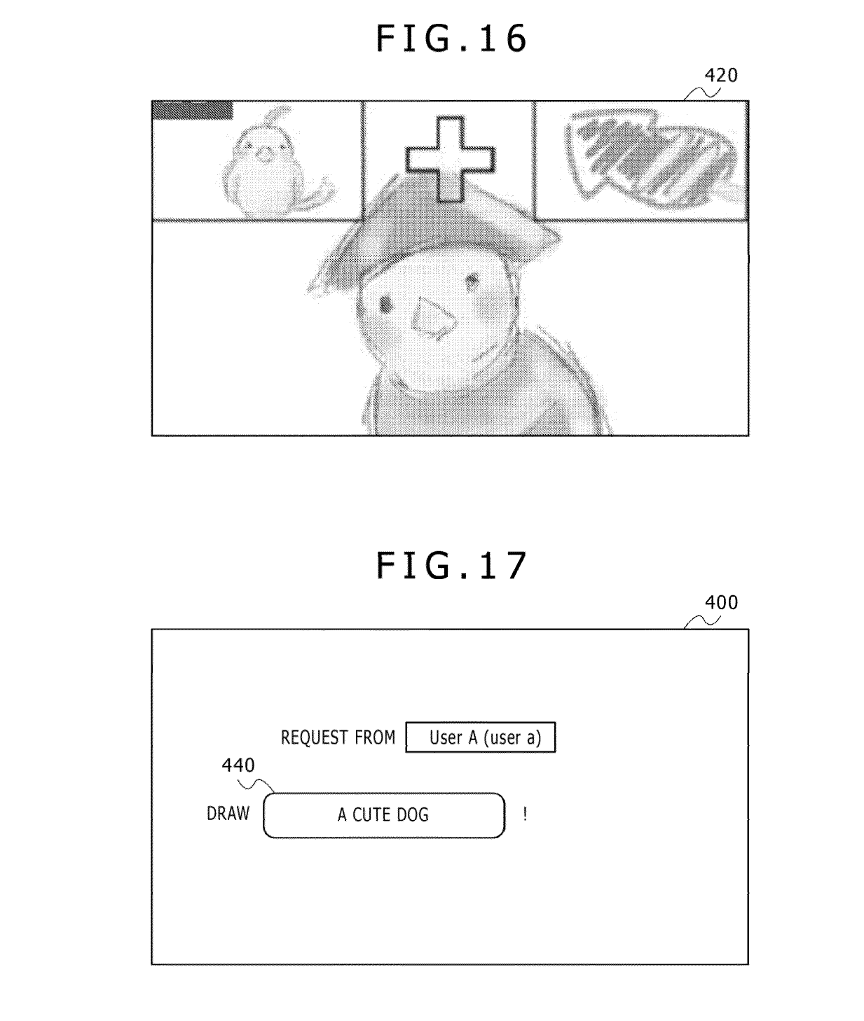

Referring to FIG. 16, there is shown an example of a screen displayed on the display apparatus. On the drawing screen 420, the user draws an image based on the presented theme. In this case too, the image presenting section 321 may make the comment information acquiring section 311 acquire images drawn on the basis of the same theme and posted to the comment information managing server 200, displaying a list of the images onto the drawing screen 420. In addition, an image selected from the list may be arranged on the drawing screen 420 as a design.

### (4) Posting of a Theme

When the user selects a theme posting function on the menu screen, the theme proposing section 319 accepts a theme from the user. If a user proposes a theme to a particular user, the theme proposing section 319 acquires, from the comment information managing server 200, a list of users registered by the user as targets of comment information browsing or a list of users who register the user as the target of comment information browsing and presents the acquired list of users onto the screen, thereby accepting the selection of the user who proposes a theme.

When posting the comment information proposing a theme to the comment information managing server 200, the comment information posting section 312 may include, in commend information, a function identification character string indicative that the comment information proposes a theme. As described above, a character string with “#” prefixed to this function identification character string may be included in the comment information.

When posting comment information proposing a theme to a particular user to the comment information managing server 200, the comment information posting section 312 includes the user ID of a target user who proposes a theme into the comment information. As described above, a character string with “@” prefixed to the user ID may be included in the comment information.

The theme proposing section 319 notifies the point managing server 100 of predetermined points to be given to the user when the user has posted comment information proposing a theme. Consequently, predetermined points are given to the user who has posted the comment information proposing a theme.

### (5) Drawing Based on a Theme Posted by Another User

When the user selects, on the menu screen, a drawing function suitable for a theme posted by another user, the theme acquiring section 317 extracts comment information including a function identification character string indicative that the comment information proposes a theme from the comment information acquired by the comment information acquiring section 311 from the comment information managing server 200. The theme presenting section 320 displays the theme included in the extracted comment information onto the display apparatus 20. If the comment information including the user ID is found in the extracted comment information, the theme presenting section 320 preferentially displays the theme included in that comment information. The theme acquiring section 317 may extract only the comment information that includes both the ID of the user and a function identification character string indicative of the comment information proposing a theme. When the user selects the displayed theme, then the drawing control section 313 presents a drawing screen for accepting drawing from the user onto the display apparatus 20, thereby accepting drawing from the user. At this moment, the theme acquiring section 317 arranges the theme proposed to the user onto the drawing screen in advance.

When posting, to the comment information managing server 200, an image drawn by the user on the basis of a theme posted by another user by attaching the image to comment information, the comment information posting section 312 includes a character string as a theme into the comment information. As described above, a character string with “#” prefixed to the character string as a theme may be included in the comment information. Consequently, another client application and the like can recognize that the image attached to the comment information is an image drawn on the basis of the theme provided by the character string written to a hash tag included in the comment information.

When posting an image drawn by the user on the basis of a theme posted by another user to the comment information managing server 200 by attaching the image to the comment information, the comment information posting section 312 may include, in the comment information, a function identification character string indicative that the image is drawn by use of a drawing function based on the theme posted by another user in the comment information. As described above, a character string with “#” prefixed to this function identification character string may be included in the comment information.

When posting an image drawn by the user on the basis of a theme posted by another user to the comment information managing server 200 by attaching the image to the comment information, the comment information posting section 312 includes, into the comment information, the user ID of the user who has posted the theme. As described above, a character string with “@” prefixed to the user ID may be included in the comment information. When posting an image drawn by the user on the basis of the theme posted by another user, the comment information posting section 312 may post the comment information attached with the image as a reply or repost to the comment information of theme posting. Consequently, the user who has posted a theme can easily know that the image drawn on the basis of the theme posted by himself/herself has been posted.

When an image drawn on the basis of a theme posted by another user has been posted, the theme acquiring section 317 notifies the point managing server 100 of predetermined points to be given to the user. Consequently, predetermined points are given to the user who has posted the image drawn on the basis of the theme posted by another user. When an image drawn on the basis of the posted theme has been posted, the theme acquiring section 317 notifies the point managing server 100 of predetermined points to be given to the user who has posted the theme. Consequently, predetermined points are given to the user who has posted a theme.

Referring to FIG. 17, there is shown an example of screen displayed on the display apparatus. The theme presenting section 320 displays, on the theme presentation screen 400, a theme 440 acquired from the comment information managing server 200 and included in the comment information for presenting the theme. If the user accepts this theme and then draws an image, the theme acquiring section 317 arranges the theme on the drawing screen 420.

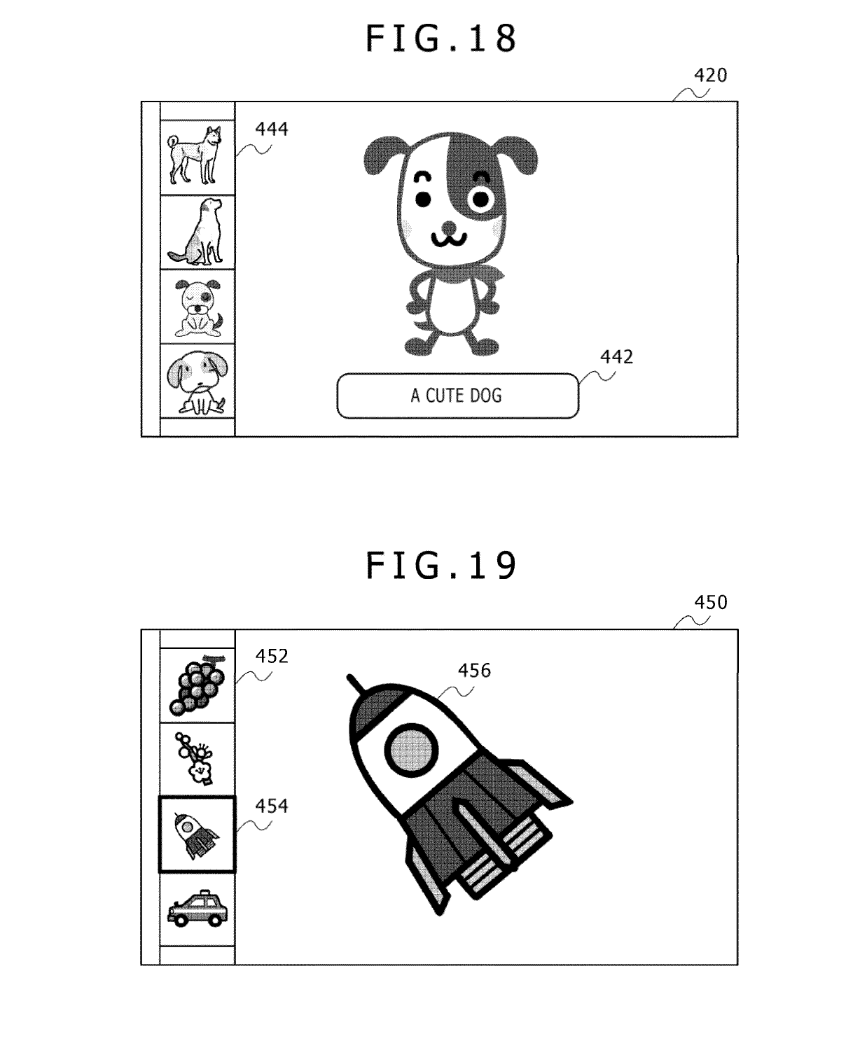

Referring to FIG. 18, there is shown an example of a screen displayed on the display apparatus. On the drawing screen 420, the user draws an image on the basis of a presented theme. The theme acquiring section 317 arranges a proposed theme 442 on the drawing screen 420 in advance. Consequently, another user can know by which theme the image has been drawn only by looking at the image. The image presenting section 321 makes the comment information acquiring section 311 acquire the images attached to the comment information with the proposed theme included in a hash tag, thereby displaying a list 444 of attached images onto the drawing screen 420. Consequently, the user is able to draw an image by seeing and referencing the image drawn by another user on the basis of the same theme, thereby enhancing user convenience. When any one of the images shown in the list 444 is selected by the user, the image presenting section 321 arranges the selected image on the drawing screen 420. Consequently, the user is able to draw an image by use of an image posted by another user as a design.

### (6) Evaluation of a Posted Image

When the user selects an evaluation function for evaluating a posted image on the menu screen, the evaluation control section 322 acquires images attached to the comment information of another user acquired by the comment information acquiring section 311 from the comment information managing server 200 and displays a list of these images on the display apparatus 20. The user selects an image to be evaluated from the displayed list of images. The drawing control section 313 presents, onto the display apparatus 20, a drawing screen for accepting drawing of a stamp image indicative of evaluation of an image from the user, thereby accepting drawing from the user. At this moment, the additional drawing control section 316 arranges the image selected by the user onto the drawing screen in advance.

When posting an image obtained by evaluating an image posted by another user to the comment information managing server 200 by attaching the image obtained by evaluation to comment information, the comment information posting section 312 includes the user ID of the user who has posted the image obtained by evaluation into the comment information. As described above, a character string with “@” prefixed to the user ID may be included in the comment information. When posting an image obtained by evaluating an image posted by another user, the comment information posting section 312 may post the comment information attached with the image as a reply or repost to the comment information attached with the image obtained by evaluation. Consequently, the user who has posted the evaluated image is able to easily know that the image obtained by evaluating the image posted by himself/herself has been posted.

When posting an image obtained by evaluating an image posted by another user to the comment information managing server 200 by attaching the image obtained by evaluation to the comment information, the comment information posting section 312 may include, into the comment information, a function identification character string indicative that the image is drawn by use of an evaluation function for evaluating an image posted by another user. As described above, a character string with “#” prefixed to this function identification character string may be included in the comment information.

The evaluation control section 322 notifies the point managing server 100 of predetermined points to be given to the user when the user evaluates an image. Consequently, predetermined points are given to the user who has posted an image obtained by evaluating an image posted by another user. The evaluation control section 322 notifies the point managing server 100 of predetermined points to be given to the user who has posted the image obtained by evaluation and a predetermined evaluation to be given to the image obtained by evaluation. Consequently, predetermined points are given also to the user who has posted the evaluated image, thereby increasing the evaluation of the evaluated image.

Referring to FIG. 19, there is shown an example of a screen displayed on the display apparatus. The evaluation control section 322 displays a list 452 of images posted by another user onto an evaluation image selection screen 450. When the user selects an image 454 to be evaluated from the list 452, the evaluation control section 322 arranges a selected image 456 on the drawing screen.

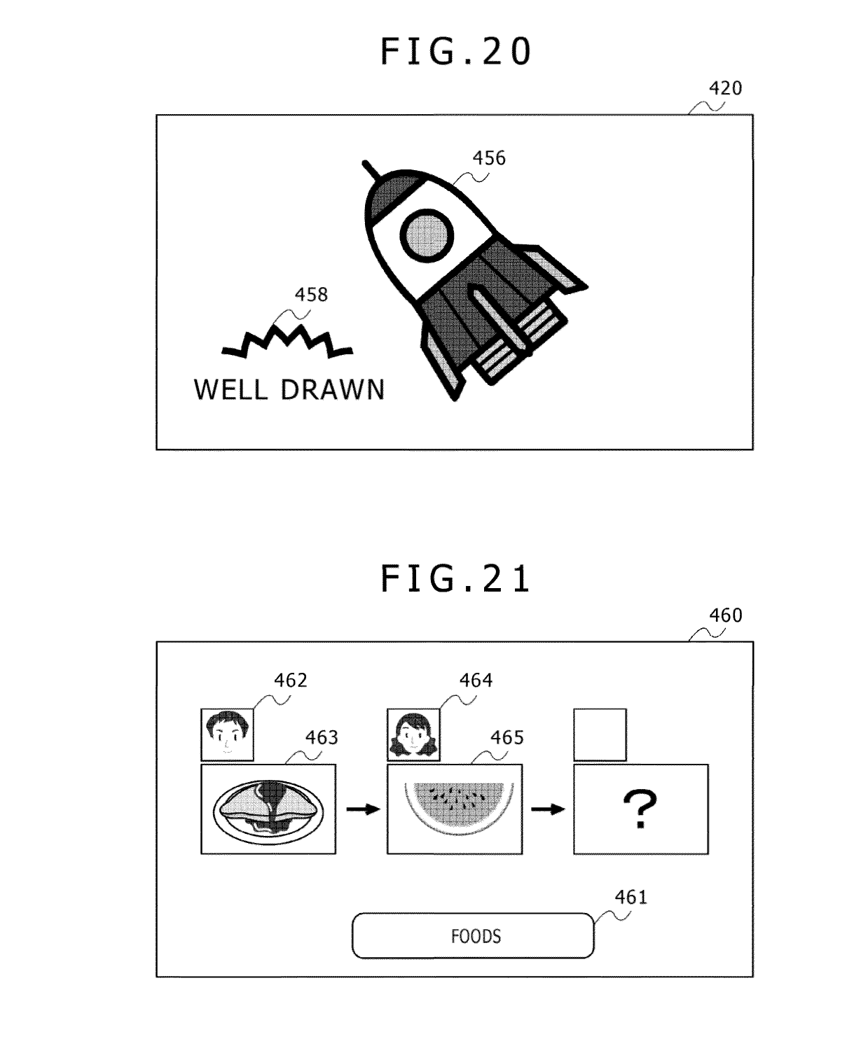

Referring to FIG. 20, there is shown an example of a screen displayed on the display apparatus. On the drawing screen 420, the user is able to additionally draw a new image 458 and so on indicative of the evaluation of the image 456 to the image 456. The evaluation control section 322 may hold stamp images of two or more types in the data holding unit 360 as images indicative of evaluation, thereby accepting the selection by the user. The evaluation control section 322 arranges the stamp image selected by the user onto the drawing screen 420.

### (7) Shiritori

When the user selects a shiritori function on the menu screen, the shiritori control section 323 accepts, from the user, the selection between the start of a shiritori and the participation in an already started shiritori. To start a shiritori, the shiritori control section 323 presents a theme of a shiritori to the user and the drawing control section 313 accepts the drawing of an image based on the theme from the user. To participate in an already started shiritori, the shiritori control section 323 extracts comment information that includes a function identification character string indicative that the comment information has been posted by use of the shiritori function from among the comment information acquired by the comment information acquiring section 311 from the comment information managing server 200. The shiritori control section 323 further makes the comment information acquiring section 311 acquire the comment information of the reply source or repost source of the extracted comment information. Consequently, a sequence of comment information posted by use of the shiritori function is acquired. The shiritori control section 323 sequentially displays the images attached to the sequence of acquired comment information onto the display apparatus 20. Consequently, the user is able to infer a word expressed by each image to grasp the progress state of a shiritori. If there is comment information including the user ID in the extracted comment information, the shiritori control section 323 preferentially displays the shiritori including this comment information. The shiritori control section 323 may extract only the comment information that includes both the ID of the user and a function identification character string indicative that the comment information proposes a theme. If the user draws a next image of the displayed shiritori, the drawing control section 313 presents a drawing screen for accepting drawing from the user onto the display apparatus 20, thereby accepting drawing from the user. At this moment, the shiritori control section 323 arranges the theme included in the comment information on the drawing screen in advance.

When posting a shiritori image to the comment information managing server 200 by attaching the shiritori image to the comment information, the comment information posting section 312 includes, into the comment information, a character string providing a shiritori theme. As described above, a character string with “#” prefixed to the character string as a theme may be included in the comment information. Consequently, the theme of a shiritori can be transmitted to the user who draws a next shiritori image.

When posting a shiritori image to the comment information managing server 200 by attaching the shiritori image to comment information, the comment information posting section 312 may include, in the comment information, a function identification character string indicative that the image is drawn by use of the shiritori function in the comment information. As described above, a character string with “#” prefixed to this function identification character string may be included in the comment information.

When posting a shiritori image to the comment information managing server 200 by attaching the shiritori image to the comment information, the comment information posting section 312 includes, into the comment information, the user ID of the user who has posted an image immediately before the shiritori. As described above, a character string with “@” prefixed to the user ID may be included in the comment information. When posting a shiritori image, the comment information posting section 312 may post the comment information attached with the image as a reply or a repost to the comment information with the immediately preceding image posted. Consequently, the user who has posted the shiritori image is easily able to know that the image immediately after himself/herself has been posted.

If the user who posts a shiritori image specifies an immediately following user, the comment information posting section 312, when posting the shiritori image to the comment information managing server 200 by attaching this shiritori image to comment information, includes the user ID of the user specified to be the immediately following user of shiritori into the comment information. As described above, a character string with “@” prefixed to the user ID may be included in the comment information.

The shiritori control section 323 notifies the point managing server 100 of predetermined points to be given to the user when a shiritori image has been posted. Consequently, predetermined points are given to the user who has posted a shiritori image.

Referring to FIG. 21, there is shown an example of a screen displayed on the display apparatus. The shiritori control section 323 displays images acquired from the comment information managing server 200 and attached to a sequence of comment information posted by use of the shiritori function onto a shiritori screen 460 in a chronological order. On the shiritori screen 460, a shiritori theme 461, an image 463 of “omuraisu (rice omelet)” posted by a user 462, and an image 465 of “suika (watermelon)” posted by a user 464 are displayed. Therefore, the user knows that the user may draw a picture of “food” of which name starts with “ka.”

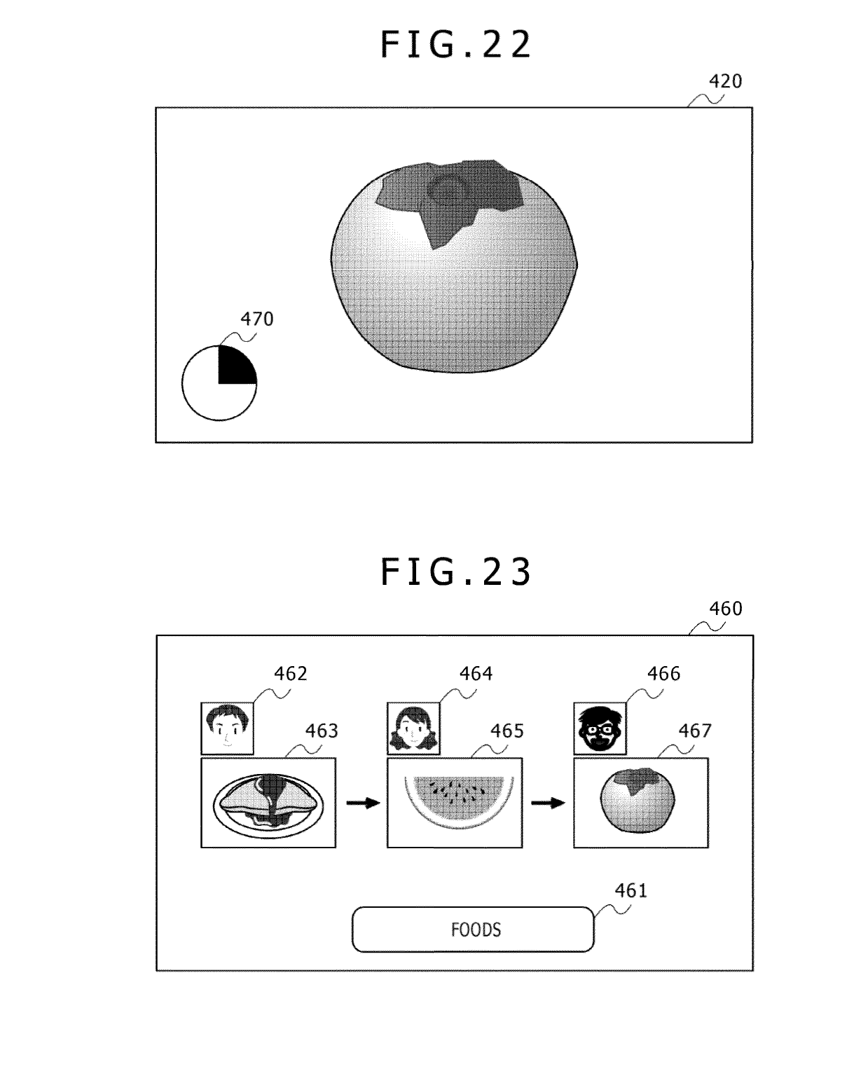

Referring to FIG. 22, there is shown an example of a screen displayed on the display apparatus. On the drawing screen 420, the user draw an image on the basis of a theme of a shiritori. The shiritori control section 323 limits a drawing time of the user to a predetermined time. When the shiritori control section 323 makes the drawing control section 313 start drawing, the shiritori control section 323 activates a timer and displays an image 470 indicative of a remaining time onto the drawing screen 420; when the predetermined time passes, the shiritori control section 323 makes the drawing control section 313 end drawing.

Referring to FIG. 23, there is shown an example of a screen displayed on the display apparatus. On the shiritori screen 460, an image 467 of “kaki (persimmon)” drawn by a user 466 is displayed in addition to the shiritori screen 460 shown in FIG. 21.

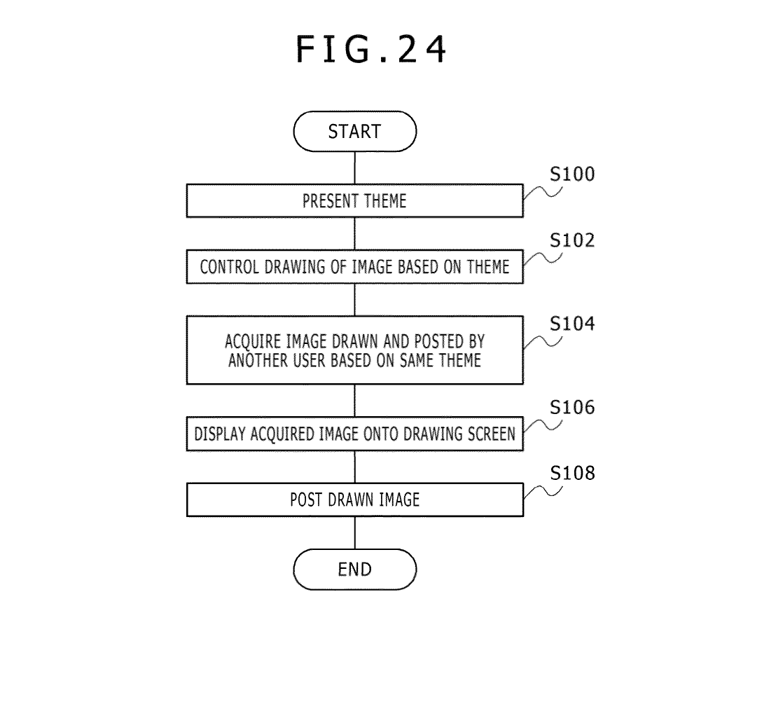

Referring to FIG. 24, there is shown a flowchart indicative of a procedure of an image processing method according to an embodiment. The theme presenting section 320 presents a theme of an image to the user (S100). The drawing control section 313 controls the drawing of an image based on the theme by the user (S102). The comment information acquiring section 311 acquires, from the comment information managing server 200, the comment information attached with an image drawn and posted to the comment information managing server 200 by another user on the basis of the same theme (S104). The image presenting section 321 displays the image attached to the comment information acquired by the comment information acquiring section 311 onto the drawing screen (S106). The comment information posting section 312 posts the comment information attached with the image drawn by the drawing control section 313 to the comment information managing server 200 (S108).

Thus, the present invention has been described on the basis of the embodiments. These embodiments are illustrative only and therefore it is to be understood by those skilled in the art that modifications of each component and each processing and combinations thereof will be apparent and such modifications are within the scope of the present invention.

In the embodiments, the user posts an image using an image posted by another user as a design, posts an image based on a theme generated from an image posted by another user, and posts an image obtained by evaluating an image posted by another user. In addition, the user terminal 300 of the user who has posted a new image notifies the point managing server 100 of evaluation of the original image. In another example, the user terminal 300 of the user who has posted the original image may acquire, from the comment information managing server 200, comment information of a reply or a repost to comment information attached with the original image or the number of replies or reposts, and notify the point managing server 100 of evaluation of the original image. In addition, the point managing server 100 may acquire, from the comment information managing server 200, comment information posted to the comment information managing server 200 by the user who manages points, give points to the user for image posting or theme proposal, and compute evaluation for the posted image.

### REFERENCE SIGNS LIST

200 Comment information managing server, 300 User terminal, 302 Communication unit, 310 Control unit, 311 Comment information acquiring section, 312 Comment information posting section, 313 Drawing control section, 314 Enlarged display control section, 315 Menu control section, 316 Additional drawing control section, 317 Theme acquiring section, 318 Theme generating section, 319 Theme proposing section, 320 Theme presenting section, 321 Image presenting section, 322 Evaluation control section, 323 Shiritori control section, 360 Data holding unit, 366 Screen generating unit.

### INDUSTRIAL APPLICABILITY

The present invention is applicable to an image processing apparatus configured to process images drawn by a user.

1. A computer program for a computer comprising:
presenting a theme of an image to a user by a theme presenting section;
accepting drawing of an image from the user by a drawing control section;
by an image presenting section, acquiring, when the drawing control section accepts drawing of an image based on the theme presented by the theme presenting section from the user, an image drawn by another user on the basis of the theme presented by the theme presenting section and posted to a comment information managing server that manages comment information posted by a plurality of users from the comment information managing server, and presenting the acquired image; and
posting the image drawn by the drawing control section to the comment information managing server by a posting section,
wherein the posting section includes a character string indicative of the theme presented by the theme presenting section into the comment information attached with the image drawn by the drawing control section.

2. The computer program according to claim 1,
wherein the drawing control section arranges in advance, upon accepting drawing of an image based on the theme from the user, the theme on a drawing screen for the user to draw an image.

3. The computer program according to claim 1,
wherein the theme presenting section acquires, from the comment information managing server, a keyword that is high in the frequency of inclusion in the comment information posted to the comment information managing server and presents the acquired keyword to the user as a theme.

4. The computer program according to claim 1,
wherein the theme presenting section presents a theme generated from the image posted to the comment information managing server to the user.

5. The computer program for computer according to claim 1, further comprising:
by a theme proposing section, accepting, from the user, posting of comment information for proposing a theme of an image to another user, and posting, to the comment information managing server, comment information that includes the theme accepted from the user and a particular character string indicative that the comment information is for proposing the theme of the image to another user.

6. The computer program according to claim 5,
wherein the theme presenting section acquires the comment information posted to the comment information managing server and presents, to the user, a theme included in the comment information that includes the particular character string.

7. An image processing apparatus comprising:
a theme presenting section configured to present a theme of an image to a user;
a drawing control section configured to accept drawing of an image from the user;
an image presenting section configured to, when the drawing control section accepts drawing of an image based on the theme presented by the theme presenting section from the user, acquire, from a comment information managing server that manages comment information posted by a plurality of users, an image drawn by another user on the basis of the theme presented by the theme presenting section and posted to the comment information managing server, and present the acquired image; and
a posting section configured to post the image drawn by the drawing control section to the comment information managing server,
wherein the posting section includes a character string indicative of the theme presented by the theme presenting section into the comment information attached with the image drawn by the drawing control section.

8. An image processing method comprising:
presenting a theme of an image to a user by a theme presenting section;
accepting drawing of an image from the user by a drawing control section;
by an image presenting section, acquiring, when the drawing control section accepts drawing of an image based on the theme presented by the theme presenting section from the user, an image drawn by another user on the basis of the theme presented by the theme presenting section and posted to a comment information managing server that manages comment information posted by a plurality of users from the comment information managing server, and presenting the acquired image; and
posting the image drawn by the drawing control section to the comment information managing server by a posting section,
wherein the posting section includes a character string indicative of the theme presented by the theme presenting section into the comment information attached with the image drawn by the drawing control section.

9. (canceled)

10. (canceled)

11. An image processing apparatus comprising:
a drawing control section configured to accept an input by a user into a touch pad, draw an image in accordance with the input, and display the drawn image onto a screen; and
an enlarge display control section configured to, upon accepting the input by the user into the touch pad, display an enlarged image of an image drawn around a position of the input and a figure indicative of the input position such that the enlarged image and figure do not overlap the input position,
wherein the drawing control section, upon accepting a first operation instruction, does not draw an image at the input position even if the input by the user into the touch pad has been accepted and, upon accepting a second operation instruction, restarts drawing of an image in accordance with the input into the touch pad.
